(19) United States
(12) Patent Application Publication
(10) Pub. No.: US 2010/0330909 A1
(43) Pub. Date: Dec. 30, 2010

(54) VOICE-ENABLED WALK-THROUGH PAIRING OF TELECOMMUNICATIONS DEVICES

(75) Inventors: Taisen Maddern, Melbourne (AU); Adrian Tan, Melbourne (AU)

Correspondence Address: FLIESLER MEYER LLP, 650 CALIFORNIA STREET, 14TH FLOOR, SAN FRANCISCO, CA, 94108, US

(73) Assignee: BLUEANT WIRELESS PTY LIMITED, Richmond (AU)

(21) Appl. No.: 12/821,057

(22) Filed: Jun. 22, 2010

Related U.S. Application Data
(60) Provisional application No. 61/220,399, filed on Jun. 25, 2009.
(60) Provisional application No. 61/220,435, filed on Jun. 25, 2009.

(51) Int. Cl. H04B 7/00

(52) U.S. Cl. 455/41.2

(57) ABSTRACT

A system and method for pairing communications devices using voice-enabled walk-through pairing. In the context of Bluetooth and other protocols, pairing allows two or more devices to be paired so that they can thereafter communicate wirelessly using the Bluetooth protocol. In accordance with an embodiment, a wireless audio headset, speaker, speakerphone, or other Bluetooth-enabled device can include a pairing logic and sound/audio playback files, which verbally walk the user through pairing the device with another Bluetooth-enabled device. This makes the pairing process easier for most users, particularly in situations that might require pairing multiple devices.

### CLAIM OF PRIORITY

This application claims the benefit of priority to U.S. Provisional Patent Application No. 61/220,399 titled “TELECOMMUNICATIONS DEVICE WITH VOICE-CONTROLLED FUNCTIONS”, filed Jun. 25, 2009; and U.S. Provisional Patent Application No. 61/220,435 titled “VOICE-ENABLED WALK-THROUGH PAIRING OF TELECOMMUNICATIONS DEVICES”, filed Jun. 25, 2009; each of which applications are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to telecommunications, audio headsets, speakers, and other communications devices, such as mobile telephones and personal digital assistants, and is particularly related to a system and method for pairing communications devices using voice-enabled walk-through pairing.

### BACKGROUND

The use of telecommunications devices, particularly mobile telephones, computers, and portable digital assistants (PDAs), continues to become more widespread, and business and casual users commonly have one or more, and in some instances several such devices. One benefit of modern devices is their ability to communicate wirelessly with one another. For example, using the Bluetooth protocol it is possible for a mobile telephone to communicate with a computer; or for a computer to communicate with a printer, as long as the two devices are properly configured to communicate with one another; which in the context of Bluetooth, this requires that the devices be paired. A common example of Bluetooth-pairing is a mobile telephone and a wireless audio headset. However, even in this simple situation the act of pairing can be difficult for some users; and pairing can become more difficult as additional devices are added.

### SUMMARY

Disclosed herein is a system and method for pairing communications devices using voice-enabled walk-through pairing. In the context of Bluetooth and other protocols, pairing allows two or more devices to be paired so that they can thereafter communicate wirelessly using the Bluetooth protocol. In accordance with an embodiment, a wireless audio headset, speaker, speakerphone, or other Bluetooth-enabled device can include a pairing logic and sound/audio playback files, which verbally walk the user through pairing the device with another Bluetooth-enabled device. This makes the pairing process easier for most users, particularly in situations that might require pairing multiple devices.

### BRIEF DESCRIPTION OF THE DRAWINGS

FIG. 1 is a flowchart of a method for pairing communications devices using voice-enabled walk-through pairing, in accordance with an embodiment.

FIG. 2 shows an illustration of a system that allows for voice-enabled walk-through pairing of headsets, speakers, or other communications devices, in accordance with an embodiment.

FIG. 3 shows an illustration of a system for providing voice-controlled functionality in a telecommunications device, in accordance with an embodiment.

FIG. 4 shows another illustration of a system for providing voice-controlled functionality in a telecommunications device, in accordance with an embodiment.

FIG. 5 shows an illustration of a headset, speaker, or other communications device, that provides voice-enabled walk-through pairing, in accordance with an embodiment.

### DETAILED DESCRIPTION

Described herein is a system and method for pairing communications devices using voice-enabled walk-through pairing. In the context of Bluetooth, pairing allows two or more devices to be paired so that they can thereafter communicate wirelessly using the Bluetooth protocol, an open wireless protocol for exchanging data over short distances from fixed and mobile devices, creating personal area networks, or another wireless technology. Generally, the system can be incorporated into a wireless audio headset, speaker, speakerphone, or other Bluetooth-enabled device that a user can use for communicating via a mobile telephone, in-car telephone, or any other type of communications system. In accordance with some embodiments, the headset, speaker, speakerphone or other device can include forward and rear microphones that allow for picking-up spoken sounds (via the forward microphone), and ambient sounds or noise (via the rear microphone), and simultaneously comparing or subtracting the signals to facilitate clearer communication.

Bluetooth pairing is generally performed by exchanging a passkey between two Bluetooth devices, which confirms that the devices (or the users of the devices) have agreed to pair with each other. Typically, pairing begins with a first device being configured to look for other devices in its immediate vicinity; and a second Bluetooth device being configured to advertise its presence to other devices in its immediate vicinity. When the two devices discover one another, they can prompt for the entry of a passkey, which must match at either device to allow a pair to be created. Some devices, for example some audio headsets, have a factory pre-set passkey, which cannot be changed by a user, but must be entered into the device being paired with.

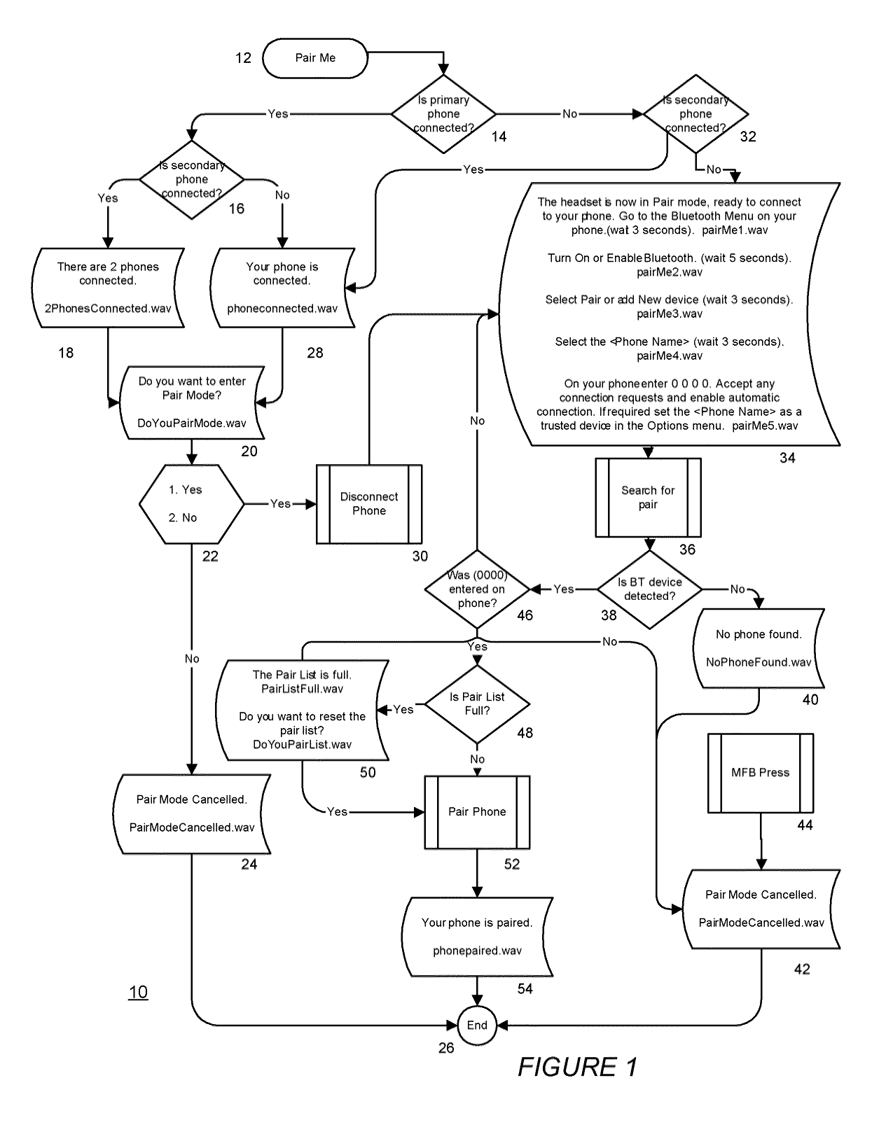

FIG. 1 is a flowchart of a method for pairing communications devices using voice-enabled walk-through pairing, in accordance with an embodiment. In particular, FIG. 1 illustrates the pairing of a headset with a primary and/or secondary telephone, although it will be evident that similar process can be applied to other types of devices.

As shown in FIG. 1, in a first step 12, a user can request that the device initiate the pairing process. In accordance with an embodiment, the headset, speaker, speakerphone, or other device can include an action button which initiates the pairing process, or allows the user to place the device into a voice recognition mode, and start the pairing process. In accordance with some embodiments the headset can operate in an always-listening or passively-listening voice recognition mode that awaits voice commands from a user, such as a request from the user to “Pair Me”, as further described in copending application “TELECOMMUNICATIONS DEVICE WITH VOICE-CONTROLLED FUNCTIONS”, Application No. 61/220,399, filed Jun. 25, 2009, and incorporated herein by reference.

In accordance with an embodiment, upon receiving the request to “Pair Me” the device, in step 14, determines whether a primary telephone is already connected.

If a primary telephone is connected, then in step 16, the device determines whether a secondary telephone is already connected. If a secondary telephone is connected, then in step 18, the device verbally notifies the user that two telephones are connected. In accordance with an embodiment, an audio file (for example, a 2PhonesConnected.wav audio file, as shown in FIG. 1) can be played through the headset or other speaker, notifying or instructing the user accordingly. In accordance with other embodiments alternative audio file formats and different wording of instructions can be provided to the user. In step 20, the device verbally asks the user whether they want to enter pair mode, to which the user can, at step 22, indicate either Yes or No, using either a voice-command or a keyboard command. If the user indicates No, then in step 24 the device instructs the user that pair mode has been canceled. In step 26, the process ends.

If previously, at step 16, the device instead determines that a primary telephone is already connected, and a secondary telephone is not connected, the device, at step 28, notifies the user that a telephone is connected, and then continues processing from step 20, as described above.

If previously, at step 14, the device instead determines that a primary telephone is not already connected then, in step 32, the device determines whether a secondary telephone is connected, and if so proceeds to step 28, where the process then continues as described above.

If previously, at step 32, the device instead determines that neither a primary telephone nor a secondary telephone is already connected, the device proceeds directly to pair mode 34. In pair mode, the device uses a script to verbally walk or instruct the user through a number of steps required for successful pairing, pausing at appropriate times either to allow the user to perform a particular step, or to wait for a response from the device. A typical pairing script can include, for example:
Headset: “The headset is now in Pair mode, ready to connect to your phone. Go to the Bluetooth Menu on your phone.”
Device waits 3 seconds; then plays pairMe1.wav (or equivalent verbal/audio notification).
Headset: “Turn On or Enable Bluetooth.”
Device waits 5 seconds; then plays pairMe2.wav (or equivalent verbal/audio notification).
Headset: “Select Pair or add New device.”
Device waits 3 seconds; then plays pairMe3.wav (or equivalent verbal/audio notification).
Headset: “Select the <Phone Name>”
Device waits 3 seconds; then plays pairMe4.wav (or equivalent verbal/audio notification).
Headset: “On your phone enter 0 0 0 0. Accept any connection requests and enable automatic connection. If required set the <Phone Name> as a trusted device in the Options menu.”
Device plays pairMe5.wav (or equivalent verbal/audio notification).

Using the pairing script such as that shown above, the device, at step 36, the searches for discoverable pairs. If no discoverable pair is found, then, in step 40, the device verbally notifies the user that no telephone has been found, and in step 42 that pair mode has been canceled. Pair mode can also be cancelled at any time by MFB Press 44.

If previously, at step 36, a discoverable pair is instead found, then in step 46 the device confirms that the correct passkey has been entered into the telephone. At step 48, if the pair list on the device is currently full, then in step 50, the device verbally notifies the user of this event, and confirms that the pair list can be refreshed. Otherwise, at step 52, the device is paired with the telephone, and, in step 54, the user is verbally notified of the successful pairing.

In the example shown above, the process can use a particular passkey and wait times that are well suited for a particular audio headset or other device. In accordance with other examples and other embodiments, other passkeys, wait times, notifications, and combinations of steps can be used, including replacing the generic <Phone Name> attribute shown above with the full or proper name of the device, to best reflect the particular device or needs thereof.

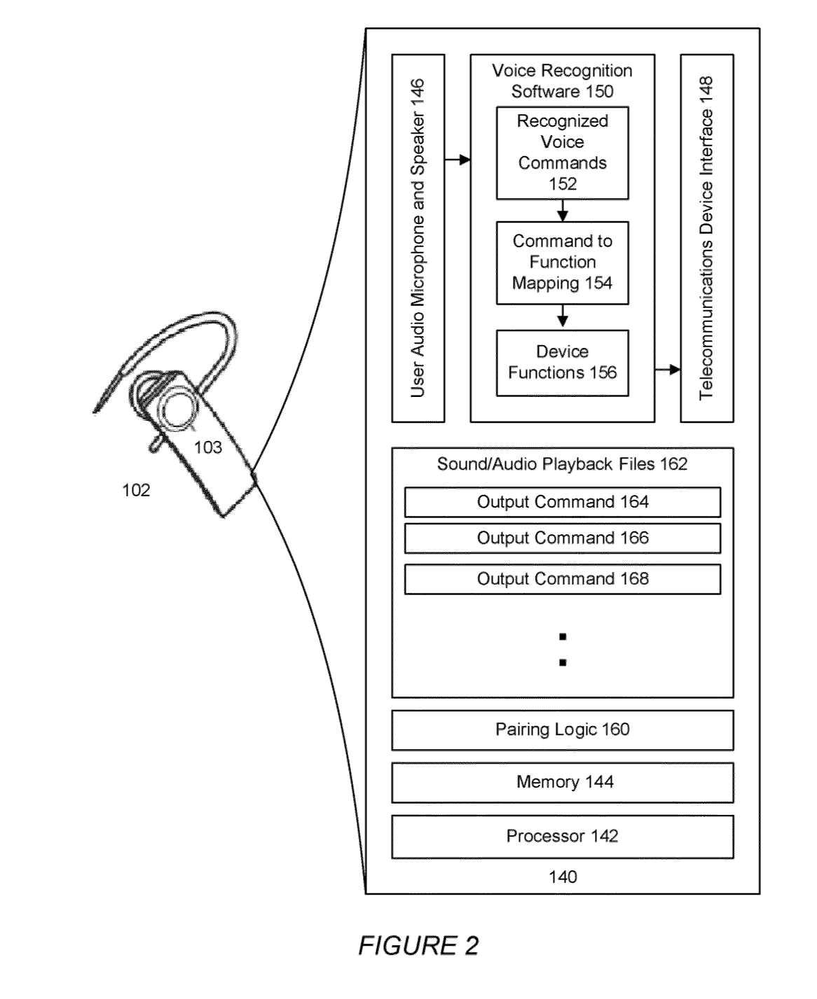

FIG. 2 shows an illustration of a headset, speakerphone, or other communications device, that provides voice-enabled walk-through pairing and other functionality, in accordance with an embodiment. As shown in FIG. 2, the headset, speakerphone or other device 102 can include an embedded circuitry or logic 140 including a processor 142, memory 144, a user audio microphone and speaker 146, and a telecommunications device interface 148. A voice recognition software 150 includes programming that recognizes voice commands 152 from the user, maps the voice commands to a list of available functions 154, and prepares corresponding device functions 156 for communication to the telephone or other device via the telecommunications device interface. A pairing logic 160 together with a plurality of sound/audio playback files and/or script of output commands 164, 166, 168 can be used to provide walk-through pairing notifications or instructions to a user. Each of the above components can be provided on or combined into one or more integrated circuits or electronic chips in a small form factor for fitting within a headset or other device.

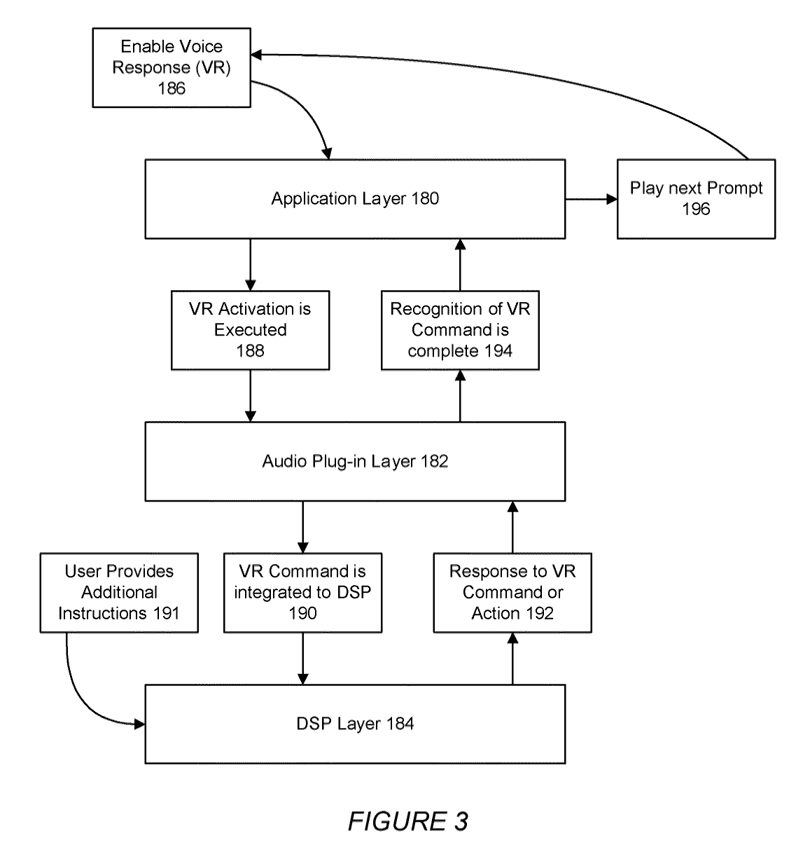

FIG. 3 shows an illustration of a system for providing voice-controlled functionality in a telecommunications device, in accordance with an embodiment. As shown in FIG. 3, in accordance with an embodiment the system comprises an application layer 180, audio plug-in layer 182, and DSP layer 184. The application layer provides the logic interface to the user, and allows the system to be enabled for voice responses (VR) 186, for example my monitoring the use of an action button, or listening for a spoken command from a user. If VR is activated 188, the user input is provided to the audio plug-in layer that provides voice recognition and/or translation of the command to a format understood by the underlying DSP layer. In accordance with different embodiments, different audio layer components can be plugged-in, and/or different DSP layers. This allows an existing application layer to be used with new versions of audio layer and/or DSP, for example in different telecommunications products. The output of the audio layer is integrated within the DSP 190, together with any additional or optional instructions from the user 191. The DSP layer is then responsible for communicating with other telecommunications device. In accordance with an embodiment, the DSP layer can utilized a Kalimba CSR BC05 chipset, which provides for Bluetooth interoperability with Bluetooth-enabled telecommunications devices. In accordance with other embodiments, other types of chipset can be used. The DSP layer then generates a response to the VR command or action 192, or performs a necessary operation, such as a Bluetooth operation, and the audio layer instructs the application layer of the completed command 194. At this point, the application layer can play additional prompts and/or receive additional commands 196 as necessary. Each of the above components can be combined and/or provided as one or more integrated software and/or hardware configurations.

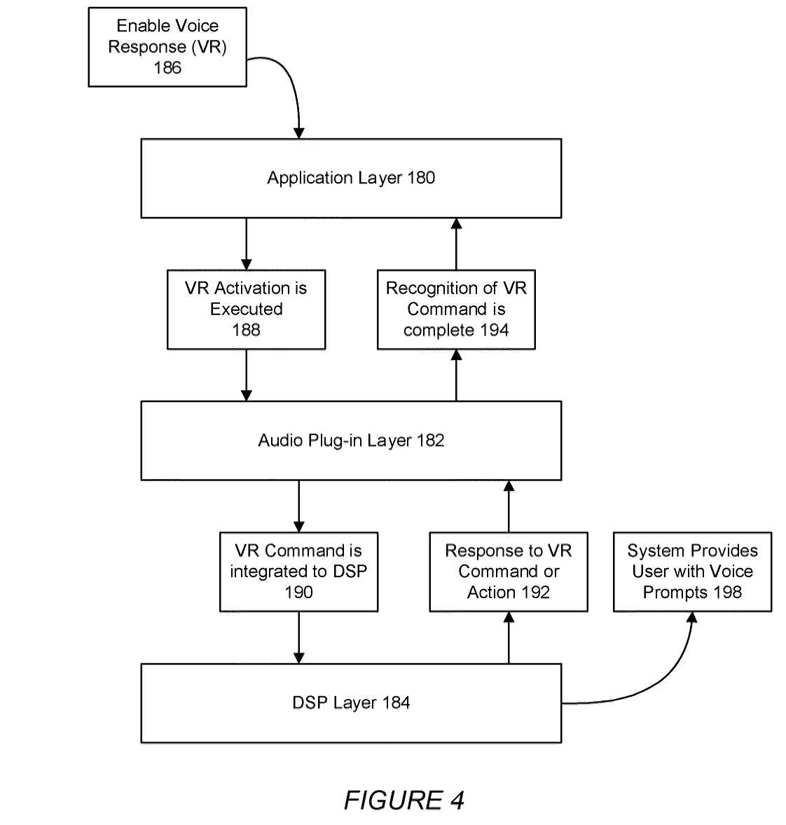

FIG. 4 shows another illustration of a system for providing voice-controlled functionality in a telecommunications device, in accordance with an embodiment. As shown in FIG. 4, in accordance with an embodiment the system can also be used to play prompts, without further input from the user. In accordance with this embodiment, the output of the audio layer is integrated within the DSP 190, but does not wait for additional or optional instructions from the user. The DSP layer is again responsible for communicating with other telecommunications device, and generating any response to the VR command or action 192, 194 except in this the DSP layer can play additional prompts 198 as necessary, without requiring further user input.

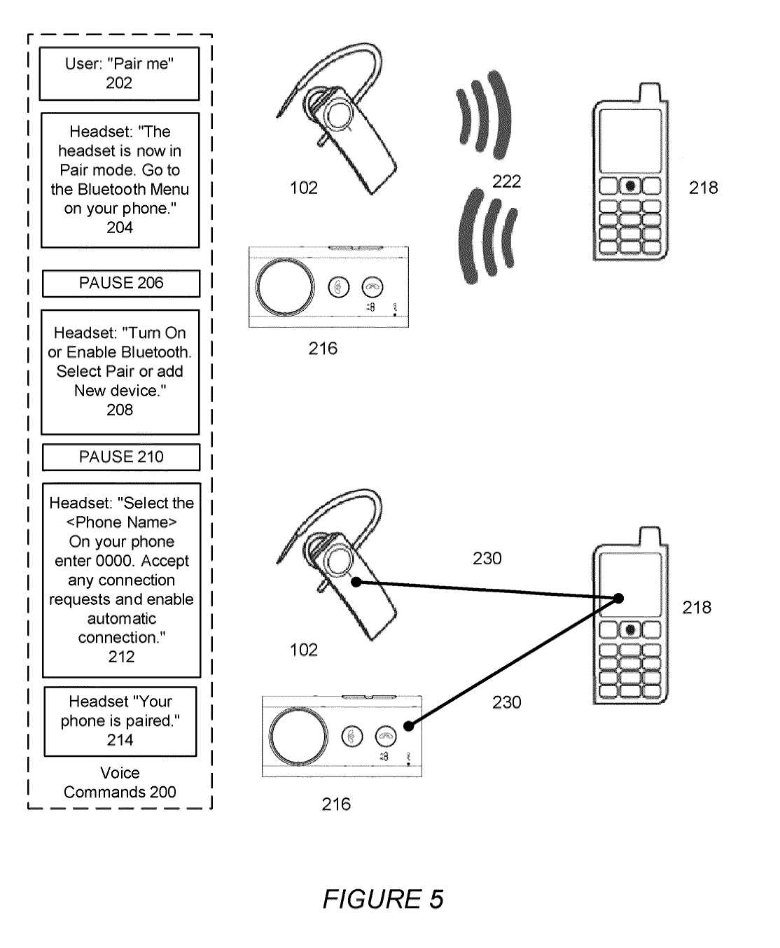

FIG. 5 shows an illustration of a mobile telephone and a headset that includes voice-enabled walk-through pairing, in accordance with an embodiment. As described above, generally, before the user can use a headset 102 or speaker 216 with a mobile telephone 218, the devices must be paired. In accordance with an embodiment the devices can be paired using the above described voice-enabled functionality in a walk-through manner. Once the user has paired the headset or speaker with, e.g. a telephone, these two devices can reconnect to each other in the future without having to repeat the pairing process.

As shown in FIG. 5, a user can utter a voice command 200, such as “Pair Me” 202, to initiate the pairing process on the headset, speaker, mobile telephone or other device. Depending on the function requested, Bluetooth or other signals 222 can be sent to and from the mobile telephone to activate functions thereon. The headset can provide additional prompts 204, 210, 212, 214 to the user, interspersed with predetermined pauses or wait-times 206, 210, as described above, which instruct the user how to perform any additional actions necessary to complete the process. When the process is complete, the headset can notify the user and, in this example, pair 230 both the headset and a speaker with the mobile telephone.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. For example, voice control. It is intended that the scope of the invention be defined by the following claims and their equivalence.

Some aspects of the present invention may be conveniently implemented using one or more conventional general purpose or specialized digital computer, computing device, machine, microprocessor, or electronic circuits, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

What is claimed is:

1. A method for providing voice-enabled walk-through pairing of telecommunications devices, comprising the steps of:
providing an audio device, such as a headset or speaker, having an embedded circuitry or logic including a processor, memory, user audio microphone and speaker, and telecommunications device interface; and
playing a script of verbal or audio instructions or notifications to assist the user in pairing the audio device, such as a headset or speaker, with another telecommunications device, such as a mobile telephone, including
receiving a request from the user for a status and/or to pair the audio device with the other telecommunications device,
determining the status of currently connected devices and/or options for pairing additional devices, and
verbally notifying the user of the status of currently connected devices and/or options for pairing additional devices, and optionally walking the user through pairing additional devices, including pausing at appropriate times to allow the user to perform a particular step and/or to wait for a response from the devices being paired.

2. The method of claim 1, wherein the audio device and mobile telephone communicate using Bluetooth, and wherein the script of verbal instructions or notifications assist the user in operating the Bluetooth features of one or more of the devices.

3. The method of claim 2, wherein the script of verbal instructions or notifications includes asking the user if they want to enter Bluetooth pair mode, and if the user acknowledges in the affirmative, then providing additional verbal instructions or notifications to assist the user in initiating Bluetooth, making the devices discoverable, entering a passkey, and pairing the devices.

4. The method of claim 1, wherein the audio device is a headset.

5. The method of claim 1, wherein the audio device is a speaker or in-car speakerphone.

6. The method of claim 4, wherein the headset, speakerphone, speaker, or other communication device includes an action button that allows the headset to be placed into a voice recognition mode.

7. The method of claim 4, wherein the headset or speakerphone operates in an always-listening or passive-listening voice recognition mode that awaits voice commands from a user.

8. The method of claim 7, wherein the headset is configured to only listen for a voice command when the headset has been paired with another device, to reduce use of battery power.

9. The method of claim 5, wherein the headset, speakerphone, speaker, or other communication device includes an action button that allows the headset to be placed into a voice recognition mode.

10. The method of claim 5, wherein the headset or speakerphone operates in an always-listening or passive-listening voice recognition mode that awaits voice commands from a user.

11. The method of claim 10, wherein the headset is configured to only listen for a voice command when the headset has been paired with another device, to reduce use of battery power.

12. The method of claim 1, wherein the wireless protocol is Bluetooth.

13. The method of claim 1, wherein the audio device includes a script of voice commands and prompts that are then used to walk the user through activating the pairing process on the mobile device.

14. The method of claim 13, wherein the audio device is a headset or speakerphone, speaker, or other communication device and wherein the script of voice commands and prompts are used to walk the user through pairing the headset or speakerphone with a mobile device.

15. A method for providing voice-enabled walk-through pairing of telecommunications devices, comprising the steps of:
providing an audio device, such as a headset or speaker, having an embedded circuitry or logic including a processor, memory, user audio microphone and speaker, and telecommunications device interface; and
playing a script of verbal or audio instructions or notifications to assist the user in pairing the audio device, such as a headset or speaker, with another telecommunications device, such as a mobile telephone, wherein the audio device and mobile telephone communicate using Bluetooth, and wherein the script of verbal instructions or notifications assist the user in operating the Bluetooth features of one or more of the devices, including
receiving a request from the user for a status and/or to pair the audio device with the other telecommunications device,
determining the status of currently connected devices and/or options for pairing additional devices, and
verbally notifying the user of the status of currently connected devices and/or options for pairing additional devices, and optionally walking the user through pairing additional devices, including providing additional verbal instructions or notifications to assist the user in initiating Bluetooth, making the devices discoverable, entering a passkey, and pairing the devices, and including pausing at appropriate times to allow the user to perform a particular step and/or to wait for a response from the devices being paired.

16. A system for providing voice-enabled walk-through pairing of telecommunications devices, comprising:
an audio device, such as a headset or speaker, having an embedded circuitry or logic including a processor, memory, user audio microphone and speaker, and telecommunications device interface; and
a script of verbal or audio instructions or notifications to assist the user in pairing the audio device, such as a headset or speaker, with another telecommunications device, such as a mobile telephone, wherein the audio device and mobile telephone communicate using Bluetooth, and wherein the script of verbal instructions or notifications assist the user in operating the Bluetooth features of one or more of the devices, including
receiving a request from the user for a status and/or to pair the audio device with the other telecommunications device,
determining the status of currently connected devices and/or options for pairing additional devices, and
verbally notifying the user of the status of currently connected devices and/or options for pairing additional devices, and optionally walking the user through pairing additional devices, including providing additional verbal instructions or notifications to assist the user in initiating Bluetooth, making the devices discoverable, entering a passkey, and pairing the devices, and including pausing at appropriate times to allow the user to perform a particular step and/or to wait for a response from the devices being paired.
